(19) United States
(12) Patent Application Publication
(10) Pub. No.: US 2022/0201821 A1
(43) Pub. Date: Jun. 23, 2022

(54) Pixel Circuit

(71) Applicants: IMEC VZW, Leuven (BE); Katholieke Universiteit Leuven, KU LEUVEN R&D, Leuven (BE)

(72) Inventors: Lynn Verschueren, Bertem (BE); Kris Myny, Heusden-Zolder (BE); Jan Genoe, Testelt (BE); Wim Dehaene, Kessel-Lo (BE); Wim Van Eessen, Kortrijk (BE); Patrick Willem, Kortrijk (BE)

(21) Appl. No.: 17/546,718

(22) Filed: Dec. 9, 2021

(30) Foreign Application Priority Data
Dec. 18, 2020 (EP) 20215452.2

(51) Int. Cl. H05B 45/397; G09G 3/32; H05B 45/44

(52) U.S. Cl. CPC H05B 45/397; G09G 2300/08; H05B 45/44; G09G 3/32

(57) ABSTRACT

A pixel circuit for driving a light-emitting diode (LED) comprises a current-mirror, comprising a primary current path and a secondary current path, arranged to mirror a current through the primary current path to the secondary current path. The current through the primary current path is settable by switching a reference current into the primary current path through a reference current line. The secondary current path is configured to drive the LED. The pixel circuit also includes a switch component arranged to switch the LED to and from the secondary current path based on one or more switch control lines.

### CROSS-REFERENCE TO RELATED APPLICATIONS

The present application is a non-provisional patent application claiming priority to European Patent Application No. 20215452.2, filed Dec. 18, 2020, the contents of which are hereby incorporated by reference.

### FIELD OF THE DISCLOSURE

This disclosure relates to a pixel circuit for driving a light-emitting diode (LED), a system comprising the pixel circuit, and to a method for driving the same.

### BACKGROUND

Displays comprising various types of LEDs, such as perovskite LEDs (PeLEDs) and micro-LEDs, which may be thin-film LEDs, are growing increasingly popular. It is desirable for such a display to offer accurate color reproduction, while still allowing for accurate control of the display brightness.

### SUMMARY

This disclosure pertains to providing a pixel circuit. One or more embodiments of the pixel circuit can allow for the abovementioned desirable display properties.

According to a first aspect, a pixel circuit for driving a light-emitting diode, LED, is provided. The pixel circuit comprises a current-mirror including a primary current path and a secondary current path. The current-mirror is arranged to mirror a current through the primary current path to the secondary current path. The current through the primary current path can be set by switching a reference current through a reference current line into the primary current path. The secondary current path is configured to drive the LED. A switch component is arranged to switch the LED to and from the secondary current path based on one or more switch control lines.

For purposes of this disclosure, a “pixel” can be a self-contained unit, comprising a pixel circuit and at least one luminous element, such as an LED. The pixel circuit can be configured to drive the one or more luminous elements. In accordance with implementations in which the pixel comprises a plurality of luminous elements, each such luminous element, if individually controllable, or a group of luminous elements, if collectively controllable, may be regarded as a “sub-pixel” of the pixel. Accordingly, the sub-pixels of a pixel can be regarded as a plurality of luminous elements controllable by the same pixel circuit.

Many types of LEDs, both of a thin-film type, and LEDs typically used for high brightness applications, exhibit wavelength shift when different currents are applied, shifting the color point of a display including the LED. Driving a fixed current through the LED, using the current-mirror, mitigates this problem. At the same time, the switch component, which allows the switching of the LED to and from the secondary current path of the current-mirror, allows for switching the LED on and off with a time modulation, such as pulse-width modulation. Thereby, the apparent brightness of the LED in the pixel may be accurately controlled, while still keeping a constant current through the LED when the LED is turned on. Thus, synergistically, the present pixel circuit allows for accurate pixel brightness control, while retaining accurate color characteristics. Moreover, this allows the peak current through the LED to be lower compared to passive matrix driving.

According to at least some of the disclosed embodiments, the current-mirror comprises a primary current-mirror transistor connected in series with the primary current path. The current method also comprises a secondary current-mirror transistor connected in series with the secondary current path. A gate of the primary current-mirror transistor is connected to a gate of the secondary current-mirror transistor at a current-mirror node. This can be a particularly simple way of arranging the current-mirror.

According to at least some of the disclosed embodiments, the switch component is a back-gate of the secondary current-mirror transistor. This can allow for the dispensation with an additional transistor as the switch component, achieving accurate pixel brightness control, while retaining accurate color characteristics, at minimal circuit complexity.

According to at least some of the disclosed embodiments, the switch component is a switch transistor connected in series with the secondary current path and the LED and controlled based on the one or more switch control lines. This can be a particularly simple way of arranging the switch component.

According to at least some of the disclosed embodiments, the one or more switch control lines comprise a switch selection line and a switch data line. The pixel circuit further comprises a switch selection transistor connected between the switch data line and the switch component and controlled by the switch selection line. The pixel circuit also includes a capacitor. A first terminal of the capacitor is connected at a point between the switch selection transistor and the switch transistor. This can allow for a particularly efficient routing of the time modulation signal to the switch component.

According to at least some of the disclosed embodiments, a second terminal of the capacitor is connected to the secondary current path, or to a voltage source. This can be a particularly simple way of arranging the capacitor to be able to be charged by the time modulation signal.

According to at least some of the disclosed embodiments, the pixel circuit further comprises a first current-setting transistor controlled by a current-selection line and connected between the primary current path and the reference current line. The pixel circuit further comprises a second current-setting transistor controlled by the current-selection line and connected between the current-mirror node and the primary current path. The pixel circuit also includes a capacitor connected at the current-mirror node. This can allow for a particularly efficient arrangement for setting the current of the current-mirror.

According to at least some of the disclosed embodiments, the second current-setting transistor is connected to the primary current path between the primary current-mirror transistor and the first current-setting transistor. This can be a particularly simple way of arranging the current-setting transistor.

According to at least some of the disclosed embodiments, the second current-setting transistor is connected to the primary current path at a terminal of the first current-setting transistor opposite to the primary current-mirror transistor. With this arrangement, the current-mirror in the pixel circuit may operate as a cascoded current-mirror. This can allow for the use of a primary current-mirror transistor and/or a secondary current-mirror transistor with lower gate lengths than otherwise possible for maintaining sufficient output resistance of the circuit, allowing to a smaller circuit size at a given performance.

According to at least some of the disclosed embodiments, the secondary current path is a first secondary current path and the secondary current-mirror transistor is a first secondary current-mirror transistor. Moreover, the pixel circuit further comprises a second secondary current-mirror transistor, in a second secondary current path of the current-mirror. A gate of the second secondary current-mirror transistor is connected to the current-mirror node. This can allow for increased flexibility in the pixel, for example through driving different reference currents though the pixel circuit, or using the same pixel circuit for several sub-pixels.

According to at least some of the disclosed embodiments, the LED is configured to be driven by the first secondary current path and the second secondary current path. This can enable driving two or more different reference currents through the LED, and allowing for better control of the brightness.

According to at least some of the disclosed embodiments, the LED is a first LED of a first subpixel and the second secondary current-mirror transistor is connected in series with a second LED of a second subpixel. This can allow for using the current-mirror of the pixel circuit for driving several sub-pixels, increasing flexibility.

According to a second aspect, a system provided. The system comprises a plurality of pixel circuits according to the first aspect. The system also includes a control block configured to apply a time modulation, such as pulse-width modulation, PWM at the one or more switch control lines. The second aspect may generally present the same or corresponding features as the first aspect. Embodiments described above in conjunction with the first aspect, and throughout this disclosure, are compatible with this second aspect.

According to a third aspect, a method for controlling a pixel circuit for driving a light-emitting diode, LED is provided. The method includes setting a current for driving the LED by switching a reference current into a primary current path of a current-mirror configured to mirror a current of the primary current path to a secondary current path. The method also includes connecting the LED to the secondary current path based on one or more switch control lines.

According to at least some of the disclosed embodiments, the method further comprises applying a time modulation, such as pulse-width modulation, PWM, at the one or more switch control lines. The third aspect may generally present the same or corresponding features as the first aspect. Embodiments described above in conjunction with the first aspect, and throughout this disclosure, are compatible with this third aspect.

### BRIEF DESCRIPTION OF THE FIGURES

The above, as well as additional features will be better understood through the following illustrative and non-limiting detailed description of example embodiments, with reference to the appended drawings. In the drawings, like reference numerals will be used for like elements unless stated otherwise.

FIG. 1, FIG. 2, FIG. 3, FIG. 4, FIG. 5, FIG. 6, and FIG. 7 show respective pixel circuits according to an example embodiment.

FIG. 8 shows a system comprising a pixel circuit according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

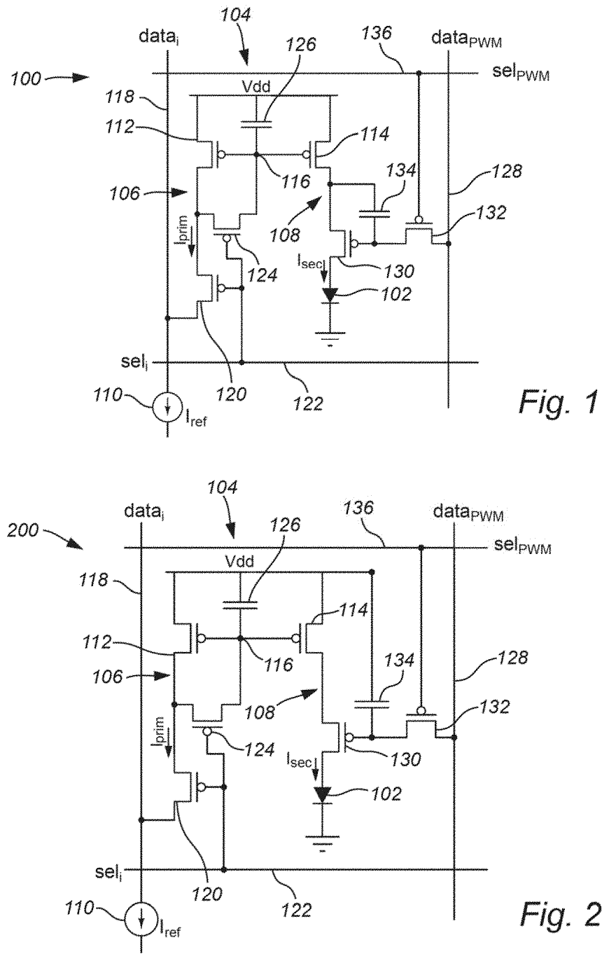

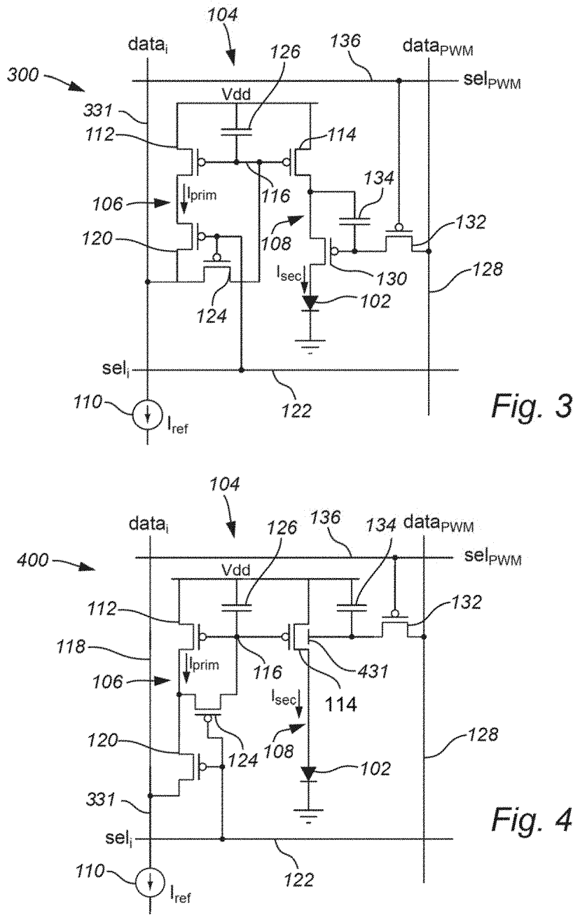

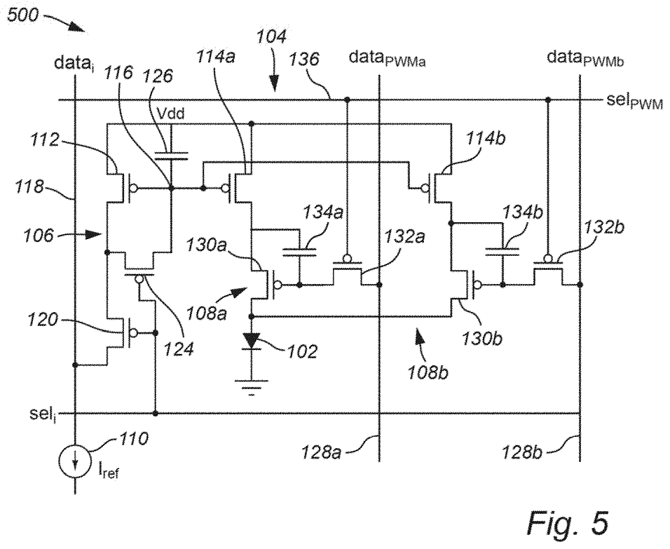

FIG. 1 shows a pixel circuit 100, which is configured for driving a light-emitting diode (LED) 102.

The pixel circuit 100 comprises a current-mirror 104. The current-mirror comprises a primary current path 106 and a secondary current path 108 and is arranged so that a current Iₚᵣᵢₘ through the primary current path 106 is mirrored, i.e., replicated, as a current I_{sec} through the secondary current path 108, as will be explained below.

As shown, the primary current path 106 may run from a supply voltage V_{dd} and to a reference current source 110. The secondary current path may run between the supply voltage V_{dd} and ground.

As shown, the LED 102 may be connected in series with the secondary current path 108, the secondary current path 108 thereby being configured to drive the LED 102, which may, for example, be a perovskite LED (PeLED), a mini-LED, or a micro-LED. Further, or additionally, the LED may, for example, be a thin-film LED.

As shown, the current-mirror 104 may comprise a primary current-mirror transistor 112 connected in series with the primary current path 106. For example, as shown, a first terminal of primary current-mirror transistor 112, which may be a source terminal or a drain terminal, may be connected to the supply voltage V_{dd}, with the primary current path 106 running through the primary current-mirror transistor 112 from the first terminal to a second terminal of the primary current-mirror transistor 112, which may be the other of the source terminal or the drain terminal of that transistor. Further, a gate terminal of the primary current-mirror transistor 112 may be connected to a current-mirror node 116.

Further, and similarly, the current-mirror 104 may comprise a secondary current-mirror transistor 114 connected in series with the secondary current path 108. For example, as shown, a first terminal of secondary current-mirror transistor 114, which may be a source terminal or a drain terminal, may be connected to the supply voltage V_{dd}, with the secondary current path 108 running through the secondary current-mirror transistor 114 from the first terminal to a second terminal of the secondary current-mirror transistor 114, which may be the other of the source terminal or the drain terminal of the secondary current-mirror transistor 114. Further, a gate terminal of the secondary current-mirror transistor 114 may be connected to the current-mirror node 116.

The gate terminals of the primary current-mirror transistor 112 and the secondary current-mirror transistor 114 being connected at the current-mirror node 116 allows for the current-mirror 104 to mirror the current Iₚᵣᵢₘ of the primary current path 106 in the current I_{sec} through the secondary current path 108. It will be understood that other current-mirror arrangements are possible and contemplated.

Still, with reference to FIG. 1, the pixel circuit 100 is connectable to a reference current line 118 (i.e., a reference current line dataᵢ). The reference current source 110 is connected in series with the reference current line 118.

The current Iₚᵣᵢₘ through the primary current path 106 is settable by switching a reference current I_{ref} through the reference current line 118 into the primary current path 106.

For example, as shown in FIG. 1, the pixel circuit 100 may comprise a first current-setting transistor 120. The gate terminal of the first current-setting transistor 120 is connected to a current-selection line selᵢ (e.g., the current-selection line 122), which thereby controls the first current-setting transistor 120. Moreover, two other terminals of the first current-setting transistor 120, which may be source and drain terminals, are connected between the primary current path 106 and the reference current line 118, i.e., in series with both. Thus, through a signal, e.g., a high state on the current-selection line 122, the first current-setting transistor 120 becomes conductive between the source and drain terminals of the first current-setting transistor 120, so that the reference current I_{ref} through the reference current line 118 is switched into the primary current path 106.

Further, still with reference to FIG. 1, the pixel circuit 100 may comprise a second current-setting transistor 124. The gate terminal of the second current-setting transistor 124 is connected to the current-selection line 122, which thereby controls the second current-setting transistor 124.

Moreover, two other terminals of the second current-setting transistor 124, which may be source and drain terminals, are connected between the current-mirror node 116 and the primary current path 106, at a point between the primary current-mirror transistor 112 and the first current-setting transistor 120. Thus, through a signal, e.g., a high state on the current-selection line 122, the second current-setting transistor 124 becomes conductive between the source and drain terminals of the second current-setting transistor 124, so that a capacitor 126, connected between the supply voltage V_{dd} and the current-mirror node 116 may be charged to a value corresponding to the current-mirror 104 mirroring the reference current, as will be explained further below.

Other arrangements for switching the reference current I_{ref} through the reference current line 118 into the primary current path 106 are possible and contemplated within the scope of the present disclosure.

Typically, the pixels circuits of a display may be arranged in a two-dimensional grid, for example a rectangular or quadratic grid. The pixels of a specific row of the grid may be connected to the same current-selection line (e.g., the current-selection line 122) and the same switch selection line (e.g., the switch selection line 136), while the pixels of a specific column of the grid may be connected to the same reference current line (e.g., the reference current line 118) and the same switch data line (e.g., the switch data line 128).

In other words, in the pixel circuit 100, the primary current-mirror transistor 112 and the secondary current-mirror transistor 114 define the current-mirror 104. The first current-setting transistor 120 and the second current-setting transistor 124 function as selection transistors, which may select which row of pixels a reference current line 118 applies. The reference current is set by storing an appropriate charge on the capacitor 126 connected at the current-mirror node 116 to the gate terminals of the primary current-mirror transistor 112 and the secondary current-mirror transistor 114.

When the current-selection line 122 is active, the first current-setting transistor 120 is conducting, for all pixels in the corresponding row, and thus the respective reference current lines data (e.g., the reference current line 118) are active for that row. The reference current line 118 in each respective column is then connected to the drain and gate of the primary current-mirror transistor 112. Then, the reference current I_{ref}, flowing through the reference current line 118, can flow through the first current-setting transistor 120 and either the second current-setting transistor 124—for changing the charge on the capacitor 126—or through the primary current-mirror transistor 112 towards the supply voltage V_{DD}. When the charge on the capacitor 126 reaches the appropriate amount for mirroring the reference current, the current through the primary current-mirror transistor 112 will be equal to the reference current I_{ref}, and hence there will be no current though the second current-setting transistor 124, retaining the appropriate charge on the capacitor 126.

Since the primary current-mirror transistor 112 and the secondary current-mirror transistor 114 are configured to define the current-mirror 104, the current I_{sec} flowing through the secondary current-mirror transistor 114 will be proportional to the current flowing through the primary current-mirror transistor 112, with a fixed proportionality ratio, depending on the characteristics of the primary current-mirror transistor 112 and the secondary current-mirror transistor 114 and which may be determined through matching of the primary current-mirror transistor 112 and the secondary current-mirror transistor 114. Hence, the current that will flow through the LED 102, which is equal to the current I_{sec} through the secondary current-mirror transistor 114, may be accurately set.

When the current-selection line 122 is deactivated, the first current-setting transistor 120 and the second current-setting transistor 124 will no longer be conducting between their respective source and drain terminals. Hence, the charge on the capacitor 126 will remain. Since the terminal not connected to the supply voltage V_{dd} or the current-mirror node 116 of the primary current-mirror transistor 112 thereby will be floating, no current will flow through the primary current-mirror transistor 112 in the primary current path 106. However, since an appropriate charge is still stored on the capacitor 126, leading to an appropriate voltage at the current-mirror node 116, and thus at the gate terminal of the secondary current-mirror transistor 114, an appropriate current, as set according to the above, will flow through the secondary current-mirror transistor 114 in the secondary current path 108.

Further, the pixel circuit 100 comprises a switch component arranged to switch the LED 102 to and from the secondary current path 108 based on one or more switch control lines. As an example and as shown in FIG. 1, the switch component includes a switch transistor 130.

The switch transistor 130 may, as shown, through two terminals, which may be source and drain terminals, be connected in series with the secondary current path 108, between the secondary current-mirror transistor 114 and the LED 102. In an alternative implementation (not shown), the switch transistor 130 may, at its gate terminal, be directly connected to a single switch control line, thereby being controlled by the same.

However, the switch control lines may also, as shown in FIG. 1, comprise a switch selection line 136 (i.e., a switch selection line sel_{PWM}) and a switch data line 128 (i.e., a switch data line data_{PWM}). Further, the pixel circuit 100 may comprise a switch selection transistor 132 connected through two terminals, which may be source and drain terminals, between the switch data line 128 and the gate terminal of the switch transistor 130. Further, the gate terminal of the switch selection transistor 132 may be connected to the switch data line 128, the switch selection transistor 132 thereby being controlled by the switch data line 128.

By applying a signal, e.g., a high state, on the switch selection line 136, the switch selection transistor 132 becomes conductive between the switch data line 128 and the gate terminal of the switch transistor 130, so that the switch transistor 130 may be controlled by the switch data line 128.

Further, still with reference to FIG. 1, the pixel circuit 100 may comprise a capacitor 134. A first terminal of the capacitor 134 is connected at a point between the switch selection transistor 132 and the switch transistor 130. A second terminal of the capacitor 134 is connected to the secondary current path 108, for example, as shown, at a point between the secondary current-mirror transistor 114 and the switch transistor 130. By charging the capacitor 134, the switch data signal as carried by the switch data line 128 is persistent when the switch selection line 136 goes low.

In other words, the switch transistor 130 and the switch selection transistor 132 may be used as switches, whereby the switch selection transistor 132 is used as a selection transistor to pass a switch signal, as input on the switch data line 128 to the gate terminal of the switch transistor 130 of a desired pixel circuit. Through time modulation of the switch signal, the switch transistor 130 may determine an average light intensity of the LED 102 (and thus the brightness) through connecting or disconnecting the LED 102 and the current-mirror, depending on the switch signal.

For example, the time modulation of the switch signal may comprise pulse-width modulation, PWM.

FIG. 2 shows a pixel circuit 200 according to an alternative example embodiment. The pixel circuit 200 has a structure and/or features similar to the pixel circuit 100 disclosed above in conjunction with FIG. 1, with the following differences. Instead of the second terminal of the capacitor 134 being connected to the secondary current path 108 at a point between the secondary current-mirror transistor 114 and the switch transistor 130 (as shown in FIG. 1), the second terminal of the capacitor 134 is connected to the supply voltage V_{dd}. The second terminal of the capacitor 134 is therefore connected to a voltage source.

FIG. 3 shows a pixel circuit 300 according to an alternative example embodiment. The pixel circuit 300 has a structure and/or features similar to the pixel circuit 100 disclosed above in conjunction with FIG. 1, with the following differences.

Just as in the pixel circuit 100 disclosed above in conjunction with FIG. 1, the gate terminal of the second current-setting transistor 124 is connected to the current-selection line 122, which thereby controls the second current-setting transistor 124. Further, the two other terminals of the second current-setting transistor 124, which may be source and drain terminals, are connected between the current-mirror node 116 and the primary current path 106. However, one of those two other terminals, instead of being connected to the primary current path 106 at a point between the primary current-mirror transistor 112 and the first current-setting transistor 120 (as shown in FIG. 1), is connected to the primary current path 106 at a terminal of the first current-setting transistor 120, opposite to the primary current-mirror transistor 112.

Thereby, in the pixel circuit 300 of FIG. 3, the current-mirror 104 may function as a cascoded current-mirror when both the current-selection line 122 and the switch data line 128 are in a high state. Thus, the primary current-mirror transistor 112 and the switch transistor 130 do not solely function as switches, but rather have a dual function as digital switches and analog cascode transistors. As a consequence, this allows for much lower gate lengths in the primary current-mirror transistor 112 and the secondary current-mirror transistor 114 to maintain sufficient output resistance of the circuit.

FIG. 4 shows a pixel circuit 400 according to an alternative example embodiment. The pixel circuit 400 has a structure and/or features similar to the pixel circuit 200 disclosed above in conjunction with FIG. 2, with the following differences.

The secondary current-mirror transistor 114 is a dual-gate transistor. Further, in FIG. 4, there is no separate switch transistor (i.e., the switch transistor 130 as shown in FIG. 2). A back-gate terminal 431 of the secondary current-mirror transistor 114 is connected to the switch selection transistor 132, rather than the gate terminal of the switch transistor 130 (as shown in FIG. 2). Thereby, the back-gate terminal 431 of the secondary current-mirror transistor 114 functions as the switch component. The voltage thereby applied on the back-gate terminal 431 shifts the threshold voltage V_{T} of the secondary current-mirror transistor 114 and hence, the secondary current-mirror transistor 114 is either open (no current flowing through the secondary current path 108 and nor the LED 102), or functions as part of the current-mirror 104 that provides the appropriate current to the LED 102 through the secondary current path 108.

FIG. 5 shows a pixel circuit 500 according to an alternative example embodiment. The pixel circuit 500 has a structure and/or features similar to the pixel circuit 100 disclosed above in conjunction with FIG. 1, with the following differences.

Instead of a single, secondary current path (e.g., the secondary current path 108 shown in FIG. 1), the current-mirror 104 comprises a plurality of secondary current paths. As shown in FIG. 5, the current-mirror 104 includes a first secondary current path 108a and a second secondary current path 108b, each arranged just as the single secondary current path of the pixel circuit 100 of FIG. 1 (i.e., the secondary current path 108).

In particular, each secondary current path in the plurality of secondary current paths in the example of FIG. 5 comprises a respective secondary current-mirror transistor. In other words, the first secondary current path 108a includes a first secondary current-mirror transistor 114a, and the second secondary current path 108b includes a second secondary current-mirror transistor 114b. Each respective gate terminal of the first secondary current-mirror transistor 114a and the second secondary current-mirror transistor 114b is connected to the current-mirror node 116.

Instead of a single switch data line (such as the switch data line 128 shown in FIG. 1), there is a separate switch data line for each secondary current path (such as, a first switch data line 128a and a second switch data line 128b). Further, there is a still-common switch selection line (i.e., the switch selection line 136).

Further, each secondary current path comprises a respective switch selection transistor, each connected through two terminals, which may be source and drain terminals, between the respective switch data line and the gate terminal of a respective switch transistor. For example, a first switch selection transistor 132a is connected through two terminals between a first switch data line 128a and a switch transistor 130a, and the second switch selection transistor 132b is connected through two terminals between a second switch data line 128b and a switch transistor 130b. Further, the gate terminal of each respective switch selection transistor (e.g., the first switch selection transistor 132a and the second switch selection transistor 132b) is connected to the switch selection line 136.

Additionally, in the pixel circuit 500, compared to the pixel circuit 100 shown in FIG. 1, the secondary current-mirror transistor 114 (shown in FIG. 1), functioning as a drive transistor for the secondary current path 108 (shown in FIG. 1) can be considered to have been split up into multiple transistors in parallel. As shown in FIG. 5, those multiple transistors include a first secondary current-mirror transistor 114a and a second secondary current-mirror transistor 114b. This makes it possible to drive two or more different reference currents through the LED 102.

The first secondary current-mirror transistor 114a and the second secondary current-mirror transistor 114b may have different characteristics, and thus provide different currents in the first secondary current path 108a and second secondary current path 108b, respectively. It should be noted that this implementation is not limited to two different secondary current paths (e.g., the first secondary current path 108a and second secondary current path 108b) and two different secondary current-mirror transistors (e.g., the first secondary current-mirror transistor 114a and the second secondary current-mirror transistor 114b). Rather, it is possible to have a different number of parallel secondary current-mirror transistors and secondary current paths, with corresponding switch transistors and switch selection transistors.

In the example of FIG. 5, the secondary current paths (that is, the first secondary current path 108a and the second secondary current path 108b) are connected in parallel, and each in series with the LED, so that the LED 102 is configured to be driven by the first secondary current path 108a and the second secondary current path 108b. However, the secondary current path may also be connected to different LED, as will be exemplified below in conjunction with FIG. 6.

Further still, the pixel circuit 500 includes a capacitor 134a and a capacitor 134b. A first terminal of the capacitor 134a is connected at a point between the first switch selection transistor 132a and the switch transistor 130a. A second terminal of the capacitor 134a is connected to the first secondary current path 108a, for example, as shown, at a point between the first secondary current-mirror transistor 114a and the switch transistor 130a. By charging the capacitor 134a, the switch data signal as carried by the switch data line data_{PWMa} 128a is persistent when the switch selection line 136 goes low.

Similarly, a first terminal of the capacitor 134b is connected at a point between the second switch selection transistor 132b and the switch transistor 130b. A second terminal of the capacitor 134b is connected to the second secondary current path 108b, for example, as shown, at a point between the second secondary current-mirror transistor 114b and the switch transistor 130b. By charging the capacitor 134b, the switch data signal as carried by the switch data line data_{PWMb} 128b is persistent when the switch selection line 136 goes low.

FIG. 6 shows a pixel circuit 600 according to an alternative example embodiment. The pixel circuit 600 has a structure and/or features similar to the pixel circuit 500 disclosed above in conjunction with FIG. 5, with the following differences.

Just like the pixel circuit 500 of FIG. 5, the current-mirror 104 comprises a plurality of current paths, but in this case a first secondary current path 108a, a second secondary current path 108b, and a third secondary current path 108c, each comprising circuitry as described above. For example, the third secondary current path 108c includes a third secondary current-mirror transistor 114c. The gate terminal of the third secondary current-mirror transistor 114c is connected to the current-mirror node 116.

However, in the pixel circuit 600, each secondary current path (i.e., the first secondary current path 108a, the second secondary current path 108b, or the third secondary current path 108c) is connected in series with a respective, separate LED (i.e., a first LED 102a, a second LED 102b, and a third LED 102c). Each LED thus forming a sub-pixel, i.e. the first LED 102a forming a first sub-pixel, the second LED 102b forming a second sub-pixel, and the third LED 102c forming a third sub-pixel.

In other words, in the pixel circuit 600 of FIG. 6, the secondary current path is shared between the first secondary current path 108a of the first sub-pixel, the second secondary current path 108b of the second sub-pixel, and the third secondary current path 108c of the third subpixel.

As one example, the first sub-pixel, the second sub-pixel, and the third sub-pixel may represent, respectively, red, green, and blue sub-pixel colors. As another example, the first sub-pixel, the second sub-pixel, and the third sub-pixel may represent sub-pixels of the same color.

The pixel circuit 600 also includes a third switch data line 128c. Additionally, a third switch selection transistor 132c is connected through two terminals between the third switch data line 128c and a switch transistor 130c.

Further still, the pixel circuit 600 includes a capacitor 134a, a capacitor 134b, and a capacitor 134c. A first terminal of the capacitor 134a is connected at a point between the first switch selection transistor 132a and the switch transistor 130a. A second terminal of the capacitor 134a is connected to the first secondary current path 108a, for example, as shown, at a point between the first secondary current-mirror transistor 114a and the switch transistor 130a. By charging the capacitor 134a, the switch data signal as carried by a switch data line data_{PWM,R} 128a is persistent when the switch selection line 136 goes low.

Similarly, a first terminal of the capacitor 134b is connected at a point between the second switch selection transistor 132b and the switch transistor 130b. A second terminal of the capacitor 134b is connected to the second secondary current path 108b, for example, as shown, at a point between the second secondary current-mirror transistor 114b and the switch transistor 130b. By charging the capacitor 134b, the switch data signal as carried by the switch data line data_{PWM,G} 128b is persistent when the switch selection line 136 goes low.

Similarly, a first terminal of the capacitor 134c is connected at a point between the third switch selection transistor 132c and the switch transistor 130c. A second terminal of the capacitor 134c is connected to the third secondary current path 108c, for example, as shown, at a point between the third secondary current-mirror transistor 114c and the switch transistor 130c. By charging the capacitor 134c, the switch data signal as carried by the switch data line data_{PWM,B} 128c is persistent when the switch selection line 136 goes low.

FIG. 7 shows a pixel circuit 700 according to an alternative example embodiment.

The pixel circuit 700 has a structure and/or features similar to the pixel circuit 100 disclosed above in conjunction with FIG. 1, with the exception that instead of comprising a single switch selection transistor (i.e., the switch selection transistor 132), the pixel circuit 700 comprises a first switch selection transistor 132a, controlled by a first switch selection line 136a, and a second switch selection transistor 132b controlled by a second switch selection line 136b. The first switch selection transistor 132a is connected to a first switch data line 128a and the second switch selection transistor 132b is connected to a second switch data line 128b. This may allow for more accurate timing for very short pulses.

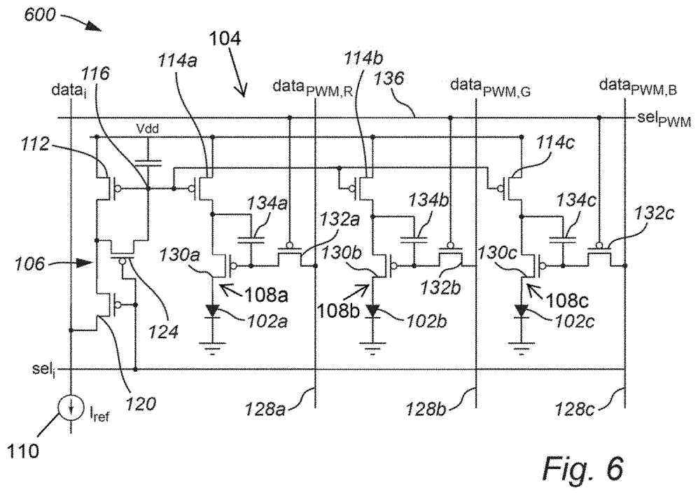

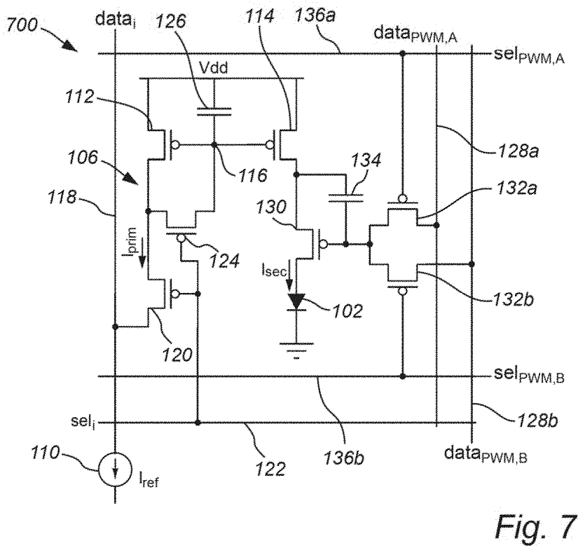

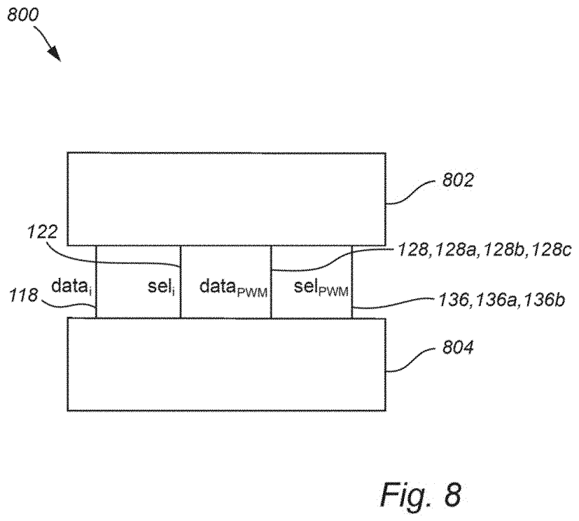

FIG. 8 shows, schematically, a system 800 comprising a control block 802 and a display backplane 804. The display backplane 804 comprises a plurality of pixel circuits 100, 200, 300, 400, 500, 600, or 700, as per the above. The control block 802 is connected to the display backplane 804 through a plurality of reference current lines 118, a plurality of current-selection lines 122, a plurality of switch data lines (e.g., the switch data line 128, the first switch data line 128a, the second switch data line 128b, the third switch data line 128c) and a plurality of switch selection lines 136, the first switch selection line 136a, the second switch selection line 136b). For the plurality of reference current lines, the control block 802 may comprise the reference current source 110 (as shown in FIG. 1 to FIG. 7).

One or more pixel circuits of the display backplane 804 may be controlled in a method comprising setting a current for driving the LED by the control block 802, through a reference current line 118 and a current-selection line 122, switching a reference current into the primary current path 106 of the current-mirror 104 configured to mirror a current of the primary current path 106 to the secondary current path (e.g., the secondary current path 108, the first secondary current path 108a, the second secondary current path 108b, or the third secondary current path 108c). This may be performed by a scanning procedure, putting the selection line of respective successive rows of the display backplane 804 high and inputting appropriate reference currents on the reference current lines for the pixels in each column of that row.

Further, the control block 802 may signal the connecting of an LED 102 to the secondary current path (e.g., the secondary current path 108, the first secondary current path 108a, the second secondary current path 108b, or the third secondary current path 108c) using a switch data line (e.g., the switch data line 128, the first switch data line 128a, the second switch data line 128b, the third switch data line 128c) and a switch selection line sel_{PWM} (e.g., the switch selection line 136, the first switch selection line 136a, the second switch selection line 136b). This signalling of the control block 802 may comprise applying a time modulation, such as pulse-width modulation, PWM, at those control lines. This, too, may be performed by a scanning procedure, putting the switch selection line of respective successive rows of the display backplane 804 high and inputting appropriate switch data, possibly as time modulated, on the switch data lines for the pixels in each column of that row.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. A pixel circuit for driving a light-emitting diode (LED), comprising:
a current-mirror, comprising a primary current path and a secondary current path, arranged to mirror a current through the primary current path to the secondary current path, wherein the current through the primary current path is settable by switching a reference current through a reference current line into the primary current path and the secondary current path is configured to drive the LED; and
a switch component arranged to switch the LED to and from the secondary current path based on one or more switch control lines.

2. The pixel circuit of claim 1, wherein the switch component is a switch transistor connected in series with the secondary current path and the LED and controlled based on the one or more switch control lines.

3. The pixel circuit of claim 2, wherein:
the one or more switch control lines comprise a switch selection line and a switch data line,
the pixel circuit further comprises:
a switch selection transistor connected between the switch data line and the switch component and controlled by the switch selection line; and
a capacitor, and
a first terminal of the capacitor is connected at a point between the switch selection transistor and the switch transistor.

4. The pixel circuit of claim 3, wherein a second terminal of the capacitor is connected to the secondary current path, or to a voltage source.

5. The pixel circuit of claim 1, wherein:
the current-mirror comprises:
a primary current-mirror transistor connected in series with the primary current path; and
a secondary current-mirror transistor connected in series with the secondary current path, and
a gate of the primary current-mirror transistor is connected to a gate of the secondary current-mirror transistor at a current-mirror node.

6. The pixel circuit of claim 5, wherein the switch component is a back-gate of the secondary current-mirror transistor.

7. The pixel circuit of claim 5, wherein the switch component is a switch transistor connected in series with the secondary current path and the LED and controlled based on the one or more switch control lines.

8. The pixel circuit of claim 5, wherein:
the second current-setting transistor is connected to the primary current path between the primary current-mirror transistor and a first current-setting transistor, or
the second current-setting transistor is connected to the primary current path at a terminal of a first current-setting transistor opposite to the primary current-mirror transistor.

9. The pixel circuit of claim 5, further comprising:
a first current-setting transistor controlled by a current-selection line and connected between the primary current path and the reference current line;
a second current-setting transistor controlled by the current-selection line and connected between the current-mirror node and the primary current path; and
a capacitor connected at the current-mirror node.

10. The pixel circuit of claim 5, wherein:
the secondary current path is a first secondary current path,
the secondary current-mirror transistor is a first secondary current-mirror transistor,
the pixel circuit further comprises a second secondary current-mirror transistor in a second secondary current path of the current-mirror, and
a gate of the second secondary current-mirror transistor is connected to the current-mirror node.

11. The pixel circuit of claim 10, wherein the LED is configured to be driven by the first secondary current path and the second secondary current path.

12. The pixel circuit of claim 10, wherein the LED is a first LED of a first subpixel and the second secondary current-mirror transistor is connected in series with a second LED of a second subpixel.

13. The pixel circuit of claim 1, further comprising:
a first current-setting transistor controlled by a current-selection line and connected between the primary current path and the reference current line;
a second current-setting transistor controlled by the current-selection line and connected between a current-mirror node and the primary current path; and
a capacitor connected at the current-mirror node.

14. The pixel circuit of claim 13, wherein the second current-setting transistor is connected to the primary current path between a primary current-mirror transistor and the first current-setting transistor.

15. The pixel circuit of claim 13, wherein the second current-setting transistor is connected to the primary current path at a terminal of the first current-setting transistor opposite to a primary current-mirror transistor.

16. A system comprising:
a plurality of pixel circuits arranged according to the pixel circuit of claim 1; and
a control block configured to apply a time modulation at the one or more switch control lines.

17. A system according to claim 16, wherein the time modulation includes pulse-width modulation (PWM).

18. A method for controlling a pixel circuit for driving a light-emitting diode (LED), the method comprising:
setting a current for driving the LED by switching a reference current into a primary current path of a current-mirror configured to mirror a current of the primary current path to a secondary current path; and
connecting the LED to the secondary current path based on one or more switch control lines.

19. The method of claim 18, further comprising:
applying a time modulation at the one or more switch control lines.

20. The method of claim 19, wherein the time modulation includes pulse-width modulation (PWM).
